(19) United States
(12) Patent Application Publication
(10) Pub. No.: US 2019/0146647 A1
(43) Pub. Date: May 16, 2019

(54) METHOD AND SYSTEM FOR FACILITATING COLLABORATION AMONG ENTERPRISE AGENTS

(71) Applicant: [24]7.ai, Inc., San Jose, CA (US)

(72) Inventors: Mathangi Sri Ramchandran, Bangalore (IN); Rahul Ignatius, Bangalore (IN); Rasika Irpenwar, Bangalore (IN)

(21) Appl. No.: 16/193,367

(22) Filed: Nov. 16, 2018

(30) Foreign Application Priority Data
Nov. 16, 2017 (IN) 201741040950

(51) Int. Cl. G06F 3/0484; G06F 3/0482; G06F 17/24; G06Q 30/00

(52) U.S. Cl. CPC G06F 3/0484; G06F 3/0482; H04M 3/5175; G06Q 30/016; H04M 2203/404; G06F 17/243

(57) ABSTRACT

Method and system for facilitating collaboration among enterprise agents are disclosed. A response provided by a first agent to a first customer is tagged by the first agent. The response is tagged during an interaction between the first agent and the first customer with an intent relevant to the interaction. The tagged response is used as an agent response of a second agent during an ongoing interaction between a second agent and a second customer. The use of the response as an agent response of the second agent is facilitated if at least one intent relevant to the ongoing interaction matches the intent tagged to the response by the first agent.

### CROSS REFERENCE TO RELATED APPLICATIONS

This application claims priority to Indian provisional patent application Ser. No. 201741040950, filed Nov. 16, 2017, which is incorporated herein in its entirety by this reference thereto.

### TECHNICAL FIELD

The present technology generally relates to interactions between customers and agents of an enterprise, and more particularly to a method and system for facilitating collaboration among enterprise agents.

### BACKGROUND

Typically, a customer may wish to converse with a customer support representative of an enterprise to inquire about products/services of interest, to resolve concerns, to make payments, to lodge complaints, and the like. To serve such a purpose, the enterprises may deploy both human and automated conversational agents to interact with the customers and provide them with desired assistance.

Many times, a human agent may receive a query, which the human agent may have not addressed previously. However, such a query may have been addressed by other agents. In absence of any mechanism to collaborate, currently, there is no way for the human agent to address the query in a timely manner. In many scenarios, the human agent may seek assistance from a supervisor or from a query response database to answer the query. This increases an Average Handle Time (AHT) of the agent. Moreover, as the human agent takes time to respond to the customer's query, the quality of customer experience may be degraded.

In many example scenarios, the human agents may provide responses to customers, which the customers may have liked and which may have elicited the desired response from the customers. It would be beneficial to share such endearing responses with other agents to improve the quality of respective customer interactions.

In view of the foregoing, it may be advantageous to facilitate collaboration among enterprise agents to enable the agents to provide desired assistance to the customers in a timely manner. It may also be beneficial to reduce the AHT of the human agents and improve the quality of interaction experience afforded to the customers.

### SUMMARY

In an embodiment of the invention provides a computer-implemented method for facilitating collaboration among agents of an enterprise. The method enables, by a processor, a tagging of a response provided by a first agent to a first customer during an interaction between the first agent and the first customer. The response is tagged with an intent relevant to the interaction by the first agent. The method facilitates, by the processor, the use of the response as an agent response of a second agent during an ongoing interaction between the second agent and a second customer. The use of the response is facilitated if at least one intent relevant to the ongoing interaction matches the intent tagged to the response by the first agent. The ongoing interaction between the second agent and the second customer is initiated after a completion of the interaction between the first agent and the first customer.

In an embodiment, a system for facilitating collaboration among agents of an enterprise is provided. The system includes a processor and a memory. The memory stores instructions. The processor is configured to execute the instructions and thereby cause the system to enable a tagging of a response provided by a first agent to a first customer during an interaction between the first agent and the first customer. The response is tagged with an intent relevant to the interaction by the first agent. The system facilitates the use of the response as an agent response of a second agent during an ongoing interaction between the second agent and a second customer. The use of the response is facilitated if at least one intent relevant to the ongoing interaction matches the intent tagged to the response by the first agent. The ongoing interaction between the second agent and the second customer is initiated after a completion of the interaction between the first agent and the first customer.

In an embodiment of the invention, another computer-implemented method for facilitating collaboration among agents of an enterprise is provided. The method predicts, by a processor, an intent relevant to an ongoing chat interaction between an agent and a customer based at least in part on one or more textual inputs provided by the customer during the ongoing chat interaction. The method identifies, by the processor, at least one trending response relevant to the predicted intent. The at least one trending response is identified from among a plurality of agent responses tagged by respective agents with intent matching the predicted intent. Each trending response is identified based on at least one of a recency of use and a frequency of use of the respective response in agent interactions with customers of the enterprise. The method causes, by the processor, a display of the at least one trending response during the ongoing chat interaction between the agent and the customer. The method receives, by the processor, a selection of a trending response from among the displayed at least one trending response from the agent. The selected trending response is used as an agent response of the agent during the ongoing chat interaction between the agent and the customer.

### BRIEF DESCRIPTION OF THE FIGURES

FIG. 1 is an example representation of a human agent engaged in a chat interaction with a customer of an enterprise, in accordance with an embodiment of the invention;

FIG. 2 is a block diagram of a system configured to facilitate collaboration among enterprise agents, in accordance with an embodiment of the invention;

FIG. 3A shows a simplified representation of an agent console displaying an ongoing chat interaction between a human agent and a customer of an enterprise, in accordance with an embodiment of the invention;

FIG. 3B shows a simplified representation of the agent console of FIG. 3A for illustrating a tagging of an agent response during the ongoing chat interaction, in accordance with an embodiment of the invention;

FIG. 3C shows a simplified tabular representation for illustrating a storage of a response tagged with an intent, in accordance with an embodiment of the invention;

FIG. 4A shows a simplified representation of an agent console displaying a plurality of relevant intents, in accordance with an embodiment of the invention;

FIG. 4B shows a simplified representation of the agent console of FIG. 4A displaying a plurality of trending responses tagged to a relevant intent, in accordance with an embodiment of the invention;

FIG. 5 shows a simplified representation of a UI displaying trending agents based on the recurrent usage of their responses by fellow agents, in accordance with an embodiment of the invention;

FIG. 6 is a flow diagram of a method for facilitating collaboration among enterprise agents, in accordance with an embodiment of the invention; and

FIG. 7 is a flow diagram of a method for facilitating collaboration among enterprise agents, in accordance with another embodiment of the invention.

### DETAILED DESCRIPTION

The detailed description provided below in connection with the appended drawings is intended as a description of the present examples and is not intended to represent the only forms in which the present example may be constructed or used. However, the same or equivalent functions and sequences may be accomplished by different examples.

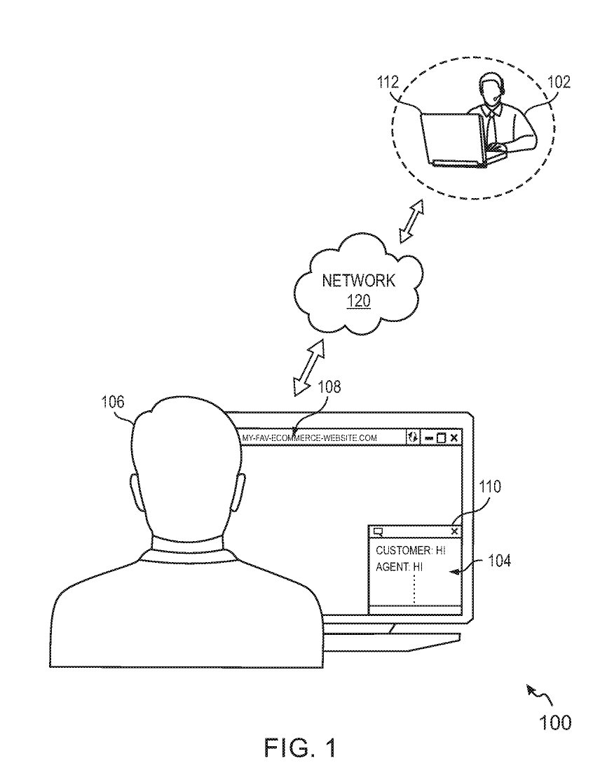

FIG. 1 is an example representation 100 of a human agent 102 engaged in a chat interaction 104 with a customer 106 of an enterprise, in accordance with an embodiment of the invention. The customer 106 is shown to be accessing an enterprise Website 108 using an electronic device (exemplarily depicted to be a desktop computer). It is noted that the Website 108 is depicted to be devoid of content for illustration purposes and that the Website 108 may display content related to enterprise products or services, promotional offers, new launches from the enterprise, and the like. Further, the Website 108 may display a widget or a pop-up, which is associated with text such as ‘Let's Chat’ or ‘Need Assistance, Click Here!’. The customer 106 may click on the widget or the pop-up to seek agent assistance. Upon receiving an input corresponding to the widget or the pop-up, a Web server hosting the Website may be configured to cause display of a chat console such as the chat console 110 on the display screen of the customer's electronic device. The customer 106 may use the chat console 110 to engage in a textual chat conversation (i.e. the chat interaction 104) with the human agent 102, for receiving desired assistance.

The human agent 102 may also use an electronic device, such as a workstation terminal 112, for communication with the customer 106. The chat interaction 104 between the customer 106 and the human agent 102 may be achieved over a communication network, such as a network 120. Examples of the network 120 may include wired networks, wireless networks, or a combination thereof. Some examples of the wired networks may include Ethernet, local area network (LAN), fiber-optic cable network, and the like. Some examples of wireless network may include cellular networks like GSM/3G/4G/CDMA networks, wireless LAN, blue-tooth or Zigbee networks, and the like. An example of combination of wired and wireless networks may include the Internet.

In an illustrative example, the customer 106 may have not been able to complete an online payment because the payment gateway may be experiencing some technical issue. A number of customers may face a similar issue and they may accordingly initiate interactions with human agents, such as the human agent 102, to check why their payment is not going through. In an example scenario, the human agent 102 may have not addressed such a query before. However, such a query may have been addressed by other agents, who may have appropriately responded to the customers engaged in interactions with them. In absence of any mechanism to collaborate, currently, there is no way for the human agent 102 to address the query in a timely manner. In many scenarios, the human agent 102 may seek assistance from a supervisor or from a query-response database to answer the query. This increases an Average Handle Time (AHT) of the human agent 102. Moreover, as the human agent 102 takes time to respond to the query of the customer 106, a quality of interaction experience afforded to the customers may be degraded.

Also, in many example scenarios, human agents may provide responses to customers, which the customers may have liked and which may have elicited the desired response from the customers. However, currently there is no mechanism to share such endearing responses with other agents to improve quality of respective customer interactions.

Various embodiments of the invention provide a method and system that are capable of overcoming these and other obstacles and providing additional benefits. More specifically, various embodiments disclosed herein present techniques for facilitating collaboration among enterprise agents. In at least one example embodiment, the system is configured to enable agents to tag responses during an ongoing chat interaction with customers. For example, the human agents may tag one or more responses, which the customers have liked or which have resulted in a desired outcome. In an illustrative example, a response, which helped solve a problem, e.g. a technical problem, or a response, which helped in early resolution of the customer query or even a response, which helped in soothing an irate customer may be tagged by the human agent. All such responses may be tagged with intents and stored in a database. Such responses may be made available to other agents during their ongoing interactions based on the match of intents between the ongoing interaction and the tagged response. An agent may choose to use a response tagged by another agent as an agent response in an ongoing interaction with the customer, thereby facilitating collaboration among agents. In some cases, responses, which are most recent or responses that are being frequently used by several agents may trend and such trending responses may be displayed to agents during their interactions for use in their respective interactions. In some embodiments, agents whose tagged responses are trending may also be rewarded with badges, which may be displayed on shared agent dashboards, thereby serving as incentives for other agents to tag their best responses.

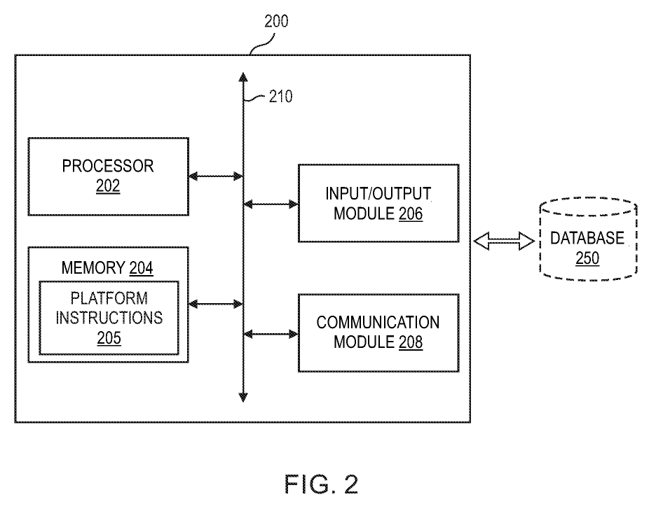

A system for facilitating collaboration among enterprise agents is explained with reference to FIG. 2.

FIG. 2 is a block diagram of a system 200 configured to facilitate collaboration among enterprise agents, in accordance with an embodiment of the invention. The term ‘enterprise agents’ or ‘agents’ as used interchangeably herein and throughout the description refers to human agents. However, the use of tagged responses may not be limited to human agents. Indeed, automated conversational agents or chatbots may also use the tagged responses in their chat interactions with the customers. The automated conversational agents or chatbots are hereinafter referred to as Virtual Agents (VA).

The term ‘facilitating collaboration among enterprise agents’ as used herein implies enabling agents to share their best responses with each other. The use of tagged responses helps in improving a quality of customer experience afforded to the customers, while at the same time reducing the AHT of agents. The term ‘enterprise’ as used herein may refer to a corporation, an institution, a small/medium sized company or even a brick and mortar entity. For example, the enterprise may be a banking enterprise, an educational institution, a financial trading enterprise, an aviation company, a consumer goods enterprise, or any such public or private sector enterprise. The enterprise may be associated with potential and existing users of products, services and/or information offered by the enterprise. Such existing or potential users of enterprise offerings are referred to herein as customers of the enterprise.

In an embodiment, the system 200 is embodied as an interaction platform with one or more components of the system 200 implemented as a set of software layers on top of existing hardware systems. In at least one embodiment, the interaction platform is communicably associated with electronic devices of the human agents of one or more enterprises and configured to receive information related to customer-agent interactions from them. The interaction platform may also be communicably coupled, over a communication network, such as the network 120 shown in FIG. 1, with interaction channels and/or data gathering Web servers linked to the interaction channels to receive information related to customer activity on the interaction channels in an ongoing manner in substantially real-time.

The system 200 includes at least one processor, such as a processor 202 and a memory 204. Although the system 200 is depicted to include only one processor, the system 200 may include more number of processors therein. In an embodiment, the memory 204 is capable of storing machine executable instructions, referred to herein as platform instructions 205. Further, the processor 202 is capable of executing the platform instructions 205. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories, such as mask ROM, PROM (programmable ROM), EPROM (erasable PROM), flash memory, RAM (random access memory), etc.; magnetic storage devices, such as hard disk drives, floppy disks, magnetic tapes, etc.; optical magnetic storage devices, e.g. magneto-optical disks, CD-ROM (compact disc read only memory), CD-R (compact disc recordable), CD-R/W (compact disc rewritable), DVD (Digital Versatile Disc), and BD (BLU-RAY® Disc).

In at least some embodiments, the memory 204 is configured to store a list of predefined intents (both programmed and learnt). Further, the memory 204 stores Natural Language Processing (NLP) algorithms and other machine learning algorithms for interpreting customer inputs and predicting customer intents based at least in part on the customer inputs.

The system 200 also includes an input/output module 206 (hereinafter referred to as ‘I/O module 206’) and at least one communication module such as the communication module 208. In an embodiment, the I/O module 206 may include mechanisms configured to receive inputs from and provide outputs to the user of the system 200. To that effect, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication module 208 may include several channel interfaces to receive information from a plurality of enterprise interaction channels. Some non-exhaustive examples of the enterprise interaction channels may include a Web channel, i.e. an enterprise Website, a voice channel, i.e. voice-based customer support, a chat channel, i.e. a chat support, a native mobile application channel, a social media channel, and the like. Each channel interface may be associated with respective communication circuitry such as for example, a transceiver circuitry including antenna and other communication media interfaces to connect to a wired and/or wireless communication network. The communication circuitry associated with each channel interface may, in at least some example embodiments, enable transmission of data signals and/or reception of signals from remote network entities, such as electronic devices of human agents, Web servers hosting enterprise Website or a server at a customer support and service center configured to maintain real-time information related to interactions between customers and agents.

In at least one example embodiment, the channel interfaces are configured to receive up-to-date information related to the customer-enterprise interactions from the enterprise interaction channels. In some embodiments, the information may also be collated from the plurality of devices used by the customers. To that effect, the communication module 208 may be in operative communication with various customer touch points, such as electronic devices associated with the customers, Websites visited by the customers, devices used by customer support representatives (for example, voice agents, chat agents, IVR systems, in-store agents, and the like) engaged by the customers and the like.

The communication module 208 may further be configured to receive information related to customer interactions with agents, such as chat interactions between customers and conversational agents, for example human agents and virtual agents, being conducted using various interaction channels, in real-time and provide the information to the processor 202. In at least some embodiments, the communication module 208 may include relevant Application Programming Interfaces (APIs) to communicate with remote data gathering servers associated with such enterprise interaction channels. Moreover, the communication between the communication module 208 and the remote data gathering servers may be realized over various types of wired or wireless networks.

In an embodiment, various components of the system 200, such as the processor 202, the memory 204, the I/O module 206, and the communication module 208 are configured to communicate with each other via or through a centralized circuit system 210. The centralized circuit system 210 may be various devices configured to, among other things, provide or enable communication between the components (202-208) of the system 200. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

The system 200 as illustrated and hereinafter described is merely illustrative of an apparatus that could benefit from embodiments of the invention and, therefore, should not be taken to limit the scope of the invention. The system 200 may include fewer or more components than those depicted in FIG. 2. In an embodiment, one or more components of the system 200 may be deployed in a Web server. In another embodiment, the system 200 may be a standalone component in a remote machine connected to a communication network and capable of executing a set of instructions (sequential and/or otherwise) to facilitate collaboration among agents of the enterprise. Moreover, the system 200 may be implemented as a centralized system or, alternatively, the various components of the system 200 may be deployed in a distributed manner while being operatively coupled to each other. In an embodiment, one or more functionalities of the system 200 may also be embodied as a client within devices, such as agents' devices. In another embodiment, the system 200 may be a central system that is shared by or accessible to each of such devices.

The system 200 is depicted to be in operative communication with a database 250. The database 250 is any computer-operated hardware suitable for storing and/or retrieving data, such as, but not limited to, repository of tagged responses (responses tagged with intents by human agents), a list of intents (both programmed and learnt), a registry of human agents and virtual agents, and the like. The database 250 may include multiple storage units such as hard disks and/or solid-state disks in a redundant array of inexpensive disks (RAID) configuration. The database 250 may include a storage area network (SAN) and/or a network attached storage (NAS) system.

In some embodiments, the database 250 is integrated within the system 200. For example, the system 200 may include one or more hard disk drives as database 250. In other embodiments, database 250 is external to the system 200 and may be accessed by the system 200 using a storage interface (not shown in FIG. 2). The storage interface is any component capable of providing the processor 202 with access to the database 250. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to the database 250.

The facilitation of collaboration among enterprise agents is hereinafter explained with reference to sample interactions between an agent of an enterprise and a customer of the enterprise. The facilitation of collaboration among a plurality of agents may not be limited to the interactions explained hereinafter.

In at least one embodiment, the communication module 208 is configured to receive a request for an interaction with a customer support representative from a customer. As explained with reference to FIG. 1, a customer may request an agent interaction by clicking on a widget or a popup displayed on the enterprise Website. The widget or the popup may be configured to display text such as ‘Let's Chat’ or ‘Need Assistance, Click Here!’. The customer may click on the widget or the popup to seek assistance. In some example scenarios, the customer may also call a customer care number displayed on the enterprise Website to request an interaction with the agent. In at least some embodiments, the communication module 208 may be configured to receive such a request for interaction from the customer and forward the request to the processor 202. The processor 202 may be configured to use initial interaction handling logic stored in the memory 204 and, in conjunction with the registry of human agents stored in the database 250, determine a human agent appropriate for interacting with the customer. In one embodiment, the next available human agent from among a pool of human agents may be selected for conducting the interaction with the customer. In another embodiment, a high-level intent may be predicted based on the customer's current and/or past interaction history and a human agent capable of handling customers for the predicted intent may be selected for conducing the interaction with the customer. In yet another embodiment, a customer's persona may be predicted based on current and past journeys of the customer on the enterprise interaction channels, and a human agent more suited to a customer's persona type may be selected for conducing the interaction with the customer. The selected human agent may thereafter initiate the interaction with the customer.

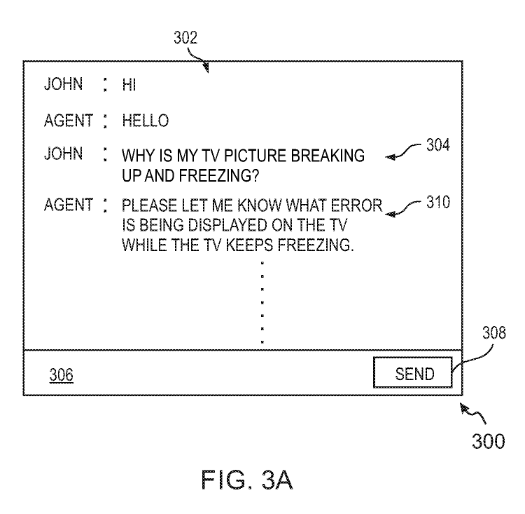

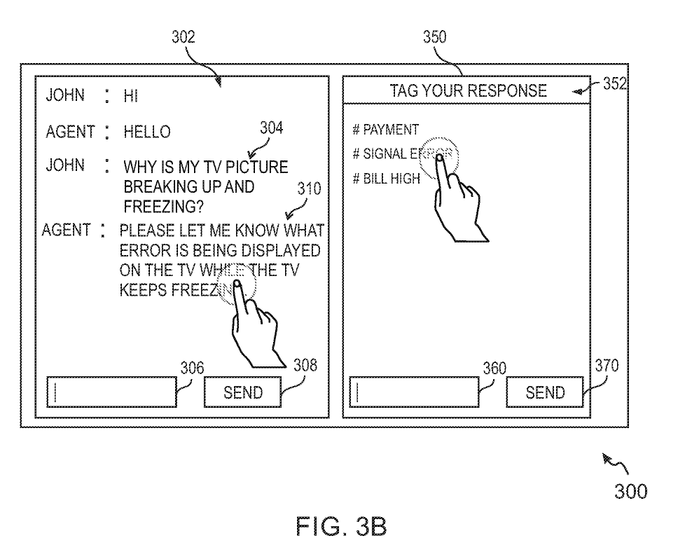

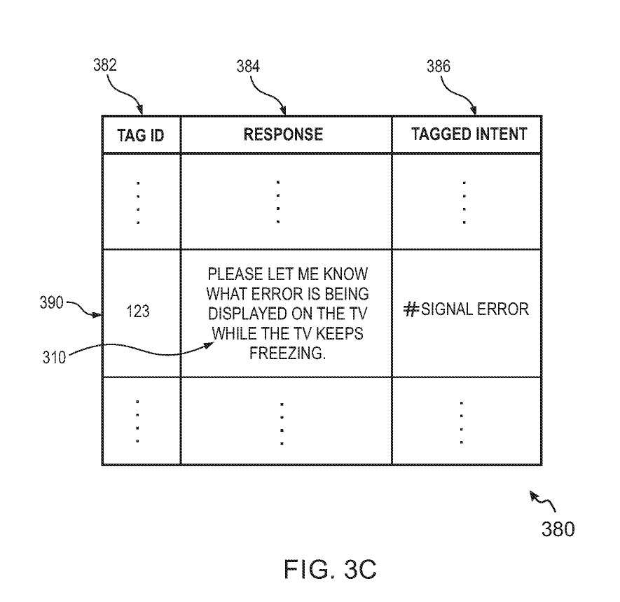

In an embodiment, the processor 202 may be configured to receive customer interaction inputs, for example chat inputs, in substantially real-time on account of the communication module 208 being in operative communication with the human agent's device. The processor 202 may further be configured to enable the human agents to tag one or more responses, during their respective ongoing chat interactions with the customers. In an illustrative example, the agent may tag a response if the agent feels that the customer has responded favorably to a response or has liked the response. In another illustrative example, the agent may tag a response if the response resulted in a preferred outcome such as for example, a completed purchase transaction, a satisfactory end to a customer complaint, a high CSAT or NPS score, and the like. In yet another illustrative example, the agent may tag a response if the response caused a positive change in customer sentiment, for example an irate customer was soothed by the response, etc. In still another illustrative example, the agent may tag a response if the agent believes that other agents may be faced with a similar query and the response will be helpful to other agents. The tagging of a response is explained using an illustrative example in FIGS. 3A and 3B.

FIG. 3A shows a simplified representation of an agent console 300 displaying an ongoing chat interaction 302 between a human agent and a customer of an enterprise, in accordance with an embodiment of the invention. The ongoing chat interaction 302 is hereinafter referred to as ‘interaction 302’, the human agent engaged in the interaction 302 is hereinafter referred to as a ‘first agent’ and the customer is hereinafter referred to as a ‘first customer’.

The agent console 300 may be displayed on a display screen of an electronic device used by the first agent, such as the workstation terminal 112 of the human agent 102 of FIG. 1. The simplified representation of the agent console 300 is shown for illustration purposes and that the agent console 300 may include several other sections not shown in FIG. 3A, such as for example a response recommendation section, a section to interact with a supervisory manager, and the like.

The inputs provided by the first customer during the interaction 302 are depicted to be associated with label ‘JOHN’, and the inputs provided by the first agent are depicted to be associated with label ‘AGENT’, for illustration purposes. The first customer is depicted to have input a query 304 associated with text ‘WHY IS MY TV PICTURE BREAKING UP AND FREEZING?’ to the first agent during the interaction 302.

The agent console 300 is depicted to include a text entry section 306 capable of receiving a textual input from the first agent. The first agent may type a response in the text entry section 306 and select, either by clicking or touching, the button 308 associated with text ‘SEND’. Upon selection of the button 308, the text entered in the text entry section 306 may be displayed as part of the interaction 302 to both the chat participants. In an example scenario, the first agent is depicted to have replied to the first customer's query, i.e. query 304, with a response 310.

The response 310 is depicted to be associated with text ‘PLEASE LET ME KNOW WHAT ERROR IS BEING DISPLAYED ON THE TV WHILE THE TV KEEPS FREEZING.’

In an example scenario, the first agent may wish to share the response 310 with other agents as the other agents may face similar queries and such a response would prove handy in saving the agent time. To that effect, in at least one example embodiment, the processor 202 is configured to enable the first agent to tag a response, such as the response 310, during the interaction 302. The response 310 may be tagged to one or more customer intents, such that if any agent conversation with similar intents is detected, then such a response may be shared with the corresponding agent. Such tagging of responses, i.e. associating the responses with intents, helps the fellow agents to pick the most relevant phrases/responses and use the phrases/responses in their interactions to efficiently overcome the customer's issues. The tagging of responses is explained in further detail with reference to FIG. 3B.

FIG. 3B shows a simplified representation of the agent console 300 of FIG. 3A for illustrating a tagging of an agent response during the interaction 302, in accordance with an embodiment of the invention. As explained with reference to FIG. 3A, the agent console 300 is displayed on the display screen of an electronic device being used by the first agent for the interaction with the first customer, i.e. JOHN. The agent console 300 is depicted to display the interaction 302 of FIG. 3A. Further, the first agent may wish to tag the response 310. Accordingly, in at least one example embodiment, the first agent may provide a selection input on the response 310. In an illustrative example, the selection input may be provided using a prolonged touch input or a right click input on the response 310. The processor 202 may be configured to receive such a selection input, and in response, cause display of a widget 350 showing a plurality of options to tag at least one intent to the response 310. The widget 350 is exemplarily depicted to display a header 352 associated with text ‘TAG YOUR RESPONSE’.

In one embodiment, the plurality of options includes a listing of predefined intents. Some non-exhaustive examples of programmed or learnt intents, such as intents “#PAYMENT”, ‘#SIGNAL ERROR’, ‘#BILL HIGH’, are shown as predefined intents in the widget 350. In some example embodiments, the selection input may also cause display of a drop-down menu of intents. Further, in some embodiments, the plurality of options to tag at least one intent to the response 310 may also include a customization option (not shown in FIG. 3B) to create or define a custom intent. The first agent may choose an appropriate intent from among the predefined intents or may define a custom intent to tag to the response 310. If the first agent chooses to create a custom intent by providing a selection of the customization option (not shown in FIG. 3B), then the processor 202 is configured to cause a display of a form field, such as a form field 360, to receive a textual input corresponding to the customized intent. The textual input in such a case is representative of the intent to be tagged to the response 310. As an illustrative example, the first agent may provide a textual input corresponding to the custom intent, such as for example ‘#TV SCREEN FREEZE’ in the form field 360 and may thereafter select the button 370 associated with text ‘SEND’ to tag the response 310 to the custom intent. It is noted that the processor 202 is configured to update the list of intents if the agents have created/defined custom intents for tagging their respective responses. In an example scenario, the first agent provides a choice of an option by selecting the intent labeled ‘#SIGNAL ERROR’ for tagging the intent ‘#SIGNAL ERROR’ with the selected response 310 as shown in FIG. 3B.

In at least one example embodiment, the processor 202 may be configured to receive information related to tagging of responses in substantially real-time and may store the response along with the tagged intent as a ‘response-intent’ pair in the database 250. For example, the response 310 including text: ‘PLEASE LET ME KNOW WHAT ERROR IS BEING DISPLAYED ON THE TV WHILE THE TV KEEPS FREEZING.’ may be tagged with the intent ‘#SIGNAL ERROR’ and stored in the database 250 as exemplarily depicted in FIG. 3C.

Referring now to FIG. 3C, a simplified tabular representation 380 is shown for illustrating a storage of a response tagged with an intent, in accordance with an embodiment of the invention. As explained with reference to FIG. 3B, the first agent may provide a selection input on the response 310 and thereafter provide a choice of the intent ‘#SIGNAL ERROR’ to tag the response 310 with the intent ‘#SIGNAL ERROR’. The response 310 tagged with the intent is stored in the database 250 (the database 250 is shown in FIG. 2). It is noted that an example tabular form of storage is shown herein for illustration purposes and that the response-intent pairs may be stored in various other formats, such as for example, in form of objects, in form of entries in relational databases, and the like. Further, the tabular representation 380 is exemplarily depicted to include only three columns, such as columns 382, 384 and 386 configured to record entries related to a tag ID, a response and a tagged intent, respectively, for illustration purposes. It is noted that the tabular representation 380 may also be configured to store information (not shown in the tabular representation 380) such as a name of the agent, i.e. the name of the first agent, who has tagged the response with the corresponding intent, the time stamp of the tagging of the response, a count of a number of times the response is used in other agent interactions and a time of use of the response in other agent interactions. Tracking the count and the time of use of a response in other agent interactions may cause a trending of the respective response, as will be explained in detail later.

One example record in the tabular representation 380 is depicted in row 390 with entries corresponding to each of the columns 382, 384 and 386. More specifically, the entries in the row 390 show an example tag ID as ‘123’, the response as response 310, i.e. text ‘PLEASE LET ME KNOW WHAT ERROR IS BEING DISPLAYED ON THE TV WHILE THE TV KEEPS FREEZING.’; and the tagged intent as ‘#SIGNAL ERROR’. The tabular representation 380 may include several such entries corresponding to responses tagged with intents by a plurality of agents of the enterprise.

Referring now to FIG. 2, in at least some embodiments, the processor 202 is configured to predict possible customer intents for ongoing agent interactions and provide the agents with a respective list of responses that may be relevant to their respective interactions and which may be used by the respective agents as their responses. The prediction of customer intents for ongoing agent interactions is explained hereinafter.

In one embodiment, the processor 202 is configured to use the NLP algorithms and other machine learning algorithms stored in the memory 204 to interpret each customer input and predict one or more intents of the customer corresponding to each customer input. In some embodiments, the customer's intent is predicted solely based on the customer's input. For example, the customer may provide the following input ‘THE DELIVERY OF MY SHIPMENT HAS BEEN DELAYED BY TWO DAYS NOW. THIS IS UNACCEPTABLE!!’ to an agent. Based on such an input, the processor 202 may be configured to predict the intent as ‘#DELIVERY DELAY’. In some embodiments, the customer intent may be predicted based on past interactions of the customer on enterprise interaction channels. For example, if a customer has recently purchased an airline ticket, then the intent for requesting a chat interaction may most likely be related to confirmation of the flight time, rescheduling the journey or cancellation of the ticket. In some embodiments, the customer intent may be predicted based on current interaction of the customer on an enterprise interaction channel. For example, a customer having visited the enterprise Website may browse through a number of Web pages and may have viewed a number of products on the Website prior to requesting a chat interaction with an agent. All such activity of the customer during the current journey of the customer on the enterprise Website may be captured and used for intent prediction purposes.

In an illustrative example, content pieces such as images, hyperlinks, URLs, and the like, displayed on an enterprise Website may be associated with Hypertext Markup Language (HTML) tags or JavaScript tags that are configured to be invoked upon user selection of tagged content. The information corresponding to the customer's activity on the enterprise Website may then be captured by recording an invoking of the tags in a Web server, i.e. a data gathering server, hosting the enterprise Website. In some embodiments, a socket connection may be implemented to capture all information related to the customer activity on the Website. The captured customer activity on the Website may include information such as Web pages visited, time spent on each Web page, menu options accessed, drop-down options selected or clicked, mouse movements, hypertext mark-up language (HTML) links those which are clicked and those which are not clicked, focus events (for example, events during which the customer has focused on a link/Web page for a more than a predetermined amount of time), non-focus events (for example, choices the customer did not make from information presented to the customer (for example, products not selected or non-viewed content derived from scroll history of the customer), touch events (for example, events involving a touch gesture on a touch-sensitive device such as a tablet), non-touch events, and the like.

In at least one example embodiment, the communication module 208 may be configured to receive such information from the Web server hosting the Web pages associated with the Website. Further, in addition to information related to the customer's activity on the enterprise interaction channel, the captured customer data may also include information such as the device used for accessing the Website, the browser and the operating system associated with the device, the type of Internet connection, whether cellular or Wi-Fi, the IP address, the location co-ordinates, and the like.

In an embodiment, the processor 202 may be configured to transform or convert such information into a more meaningful or useful form. In an illustrative example, the transformation of information may include normalization of content included therein. In some embodiments, the processor 202 may be configured to normalize customer keyword searches on the Website, personal information, such as phone numbers, email IDs, and so on.

The processor 202 is further caused to extract features from the transformed data. For example, the type of device used by the customer for requesting conversation with the agent may be identified as one feature. Similarly, the type of Internet connection may be identified as another feature. The sequence of Web pages visited by the customer prior to requesting the interaction with the agent may be identified as one feature. The category of products viewed/selected on the Web pages may be identified as another feature. Furthermore, customer conversational inputs split into n-grams, unigrams, bigrams and trigrams and the word phrases in the conversational inputs may also be selected as features.

In at least one example embodiment, the memory 204 is configured to store one or more intention prediction models, which are referred to herein as classifiers. The extracted features from the transformed customer data may then be provided to at least one classifier associated with intention prediction to facilitate prediction of the at least one intention of customer. In an embodiment, the classifiers may use any combination of the above-mentioned input features to predict the customer's likely intents.

Accordingly, as explained above, one or more customer intents may be predicted based on current input, current journey and/or past journey on the enterprise interaction channels.

In at least one embodiment, subsequent to the prediction of the customer intent, also interchangeably referred to herein as intent relevant to the ongoing interaction, the processor 202 is configured to identify at least one trending response relevant to the predicted intent. Each trending response is identified based on at least one of a recency of use and a frequency of use of the respective response in agent interactions with customers. More specifically, each trending response is identified based on how recently the response was used by fellow agents in their respective interactions with customers and how frequently the response was used by the fellow agents. The identification of the trending responses is explained in further detail below.

The repeated selection of some tagged responses in agent interactions may cause those responses to trend and be shown on the agent consoles for possible inclusion in their interactions. The tagged responses may trend not only based on their frequent usage in interactions by fellow agents but, in some cases, the responses which are related to recent events or the responses which are associated with the highest Net Promoter Score (NPS), Customer Satisfaction Score (CSAT), etc. may also trend and accordingly be displayed on the agent consoles. Some examples of recent event may be a power outage event, a sudden change in weather causing disruption of services, a local event such as a political rally or a union strike or a global event of local significance, etc. In case of occurrence of such events, the agent responses may have wider applicability as the fellow agents may also face similar queries. Accordingly, the agent responses to the recent events may be tagged with respective intents and stored in the database 250. Further, these responses may trend, i.e. be displayed on the agent consoles along with responses being frequently used, on agent consoles.

The processor 202 may be configured to identify the at least one trending response from among a plurality of agent responses tagged by respective agents with intent matching the predicted intent. For example, if an intent predicted for an ongoing interaction between an agent and a customer corresponds to ‘#PAYMENT’ intent, then all the responses tagged with such an intent, i.e. with matching intent, may be retrieved from the database 250. Then, one or more responses among the retrieved responses which are used most frequently and/or most recently used are identified as trending responses relevant to the predicted intent. The processor 202 is further configured to cause a display of at least one trending response during the ongoing chat interaction between the agent and the customer.

In an illustrative example, a particularly severe rainy day may have caused reception of TV signals to be deteriorated and thereby the customers may more likely be expected to contact the agents with the relevant queries of signal errors. Accordingly, the processor 202 may be configured to suggest the agents to tag their best responses for a signal error event that would facilitate faster response to the customers' queries. For example, an agent response such as ‘SATELLITE SIGNAL RECEPTION HAS BEEN AFFECTED ON ACCOUNT OF INCLEMENT WEATHER. PLEASE REBOOT YOUR TV AFTER 5 PM, WHEN THE WEATHER IS EXPECTED TO BE BETTER’ may be tagged with intent ‘#SIGNAL ERROR’ and such a response may trend on agent consoles.

In one embodiment, the processor 202 is configured to monitor customer sentiment or emotion scores throughout the duration of the interaction and those agent responses, which led to sizable positive change, i.e. a change above a predefined threshold, in customer sentiment or emotion may be tagged with intent by the respective agent and stored in the database 250. The CSAT or NPS score may be determined based on criteria, such as for example the customer concern was resolved or not, how long it took to resolve a customer concern, did the customer respond positively to the solution, etc. The agent responses, which helped improve the CSAT score or the NPS, may be conveyed to the respective agents who may then tag, i.e. associate, the responses with respective intents. The responses tagged with intents are then stored in the database 250 by the processor 202.

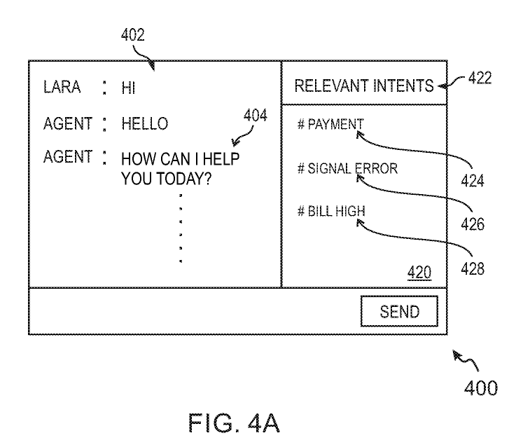

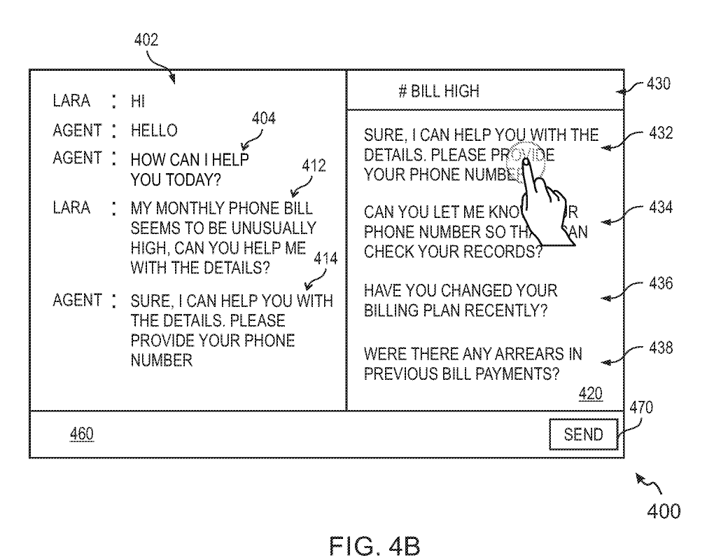

FIG. 4A shows a simplified representation of an agent console 400 displaying a plurality of relevant intents, in accordance with an embodiment of the invention. The agent console 400 is similar to the agent console 300 in that the agent console 400 may be displayed on a display screen of an electronic device being used by an agent, such as the workstation terminal 112 of the human agent 102 of FIG. 1. Further, a simplified representation of the agent console 400 is shown for illustration purposes and that the agent console 400 may include several other sections not shown in FIG. 4A, such as for example a response recommendation section, a section to interact with a supervisory manager, and the like.

The agent console 400 depicts an ongoing chat interaction 402 between the human agent and the customer. The ongoing chat interaction 402 is hereinafter referred to as ‘interaction 402’, the human agent engaged in the interaction 402 is hereinafter referred to as a ‘second agent’ and the customer is hereinafter referred to as a ‘second customer’.

The inputs provided by the second customer during the interaction 402 are depicted to be associated with label TARA′, and the inputs provided by the second agent are depicted to be associated with label ‘AGENT’, for illustration purposes. The interaction 402 is depicted to include a query 404 associated with text ‘HOW CAN I HELP YOU TODAY?’ asked by the second agent to the second customer.

As explained with reference to FIG. 2, the processor 202 is configured to receive each customer input and predict one or more intents of the customer based on analyzing the customer inputs. Because the customer intent is not clear during the initial stage of the interaction, the processor 202 may be configured to display a plurality of trending intents on a portion 420 of the agent console 400. The portion 420 is exemplarily depicted to display a header 422 showing a label ‘RELEVANT INTENTS’. Initially, the portion 420 is depicted to display intents 424, 426 and 428 associated with text “#PAYMENT”, ‘#SIGNAL ERROR’ AND ‘#BILL HIGH’, respectively. In some embodiments, these intents may be determined to be relevant to the customer-agent interaction based on a current or past activity of the customer on one or more enterprise interaction channels. For example, if a monthly bill has been recently generated for the second customer, then the interaction 402 may be related to the bill. Similarly, if the second customer has recently tried to make a purchase transaction and was unsuccessful in completing the transaction, then the second customer may have initiated the interaction to query the cause of payment failure.

As the interaction progresses, the intents displayed in the portion 420 may constantly be refined so as to match the relevance of the current conversation. Moreover, each trending intent may be associated with one or more trending responses. This is explained in detail with reference to FIG. 4B hereinafter.

FIG. 4B shows a simplified representation of the agent console 400 of FIG. 4A displaying a plurality of trending responses tagged to a relevant intent, in accordance with an embodiment of the invention. The agent console 400 shows the interaction 402 between an agent, for example the second agent, and a customer, for example the second customer, of the enterprise. The agent console 400 includes new messages exchanged by the second agent and the customer, i.e. Lara. For example, after receiving the query 404 from the second agent, the second customer, i.e. Lara, is depicted to have answered with a reply 412 displaying text ‘MY MONTHLY PHONE BILL SEEMS TO BE UNUSUALLY HIGH, CAN YOU HELP ME WITH THE DETAILS?’

The processor 202 monitoring the interaction 402 may receive the customer input, i.e. reply 412, and determine the intent as ‘#BILL HIGH’. Further, the processor 202 may be configured to fetch the top trending responses tagged to that intent, i.e. ‘#BILL HIGH’, from the database 250 and display the top trending responses on the portion 420 of the agent console 400 as shown in FIG. 4B. The portion 420 is now exemplarily depicted to display a header 430 showing a label ‘#BILL HIGH’, i.e. the intent identified to be relevant to the interaction. The portion 420 is further depicted to display top trending responses for the ‘#BILL HIGH’ intent, such as for example responses 432, 434, 436 and 438. The responses 432, 434, 436 and 438 are depicted to be associated with text: ‘SURE, I CAN HELP YOU WITH THE DETAILS. PLEASE PROVIDE YOUR PHONE NUMBER’; ‘CAN YOU LET ME KNOW YOUR PHONE NUMBER SO THAT I CAN CHECK YOUR RECORDS?’; ‘HAVE YOU CHANGED YOUR BILLING PLAN RECENTLY?’; and ‘WERE THERE ANY ARREARS IN PREVIOUS BILL PAYMENTS?’, respectively. It is noted that the responses 432, 434, 436 and 438 may have been tagged with the intent “#BILL HIGH′ by other agents, such as the first agent explained with reference to FIGS. 3A and 3B, during their respective interactions with the customers.

The second agent may choose an appropriate response from among the trending responses 432-438. In FIG. 4B, the second agent is exemplarily depicted to have selected the response 432 using a touch input. In some embodiments, the second agent may be allowed to drag and drop the appropriate response in the chat interaction display section from the portion 420. Alternatively, upon agent selection of a response, a menu tray including an option to move the response to the chat interaction section may be displayed to the second agent to enable the agent to respond to the customer” s reply 412 using a trending response. The selected response may be displayed as an answer to the customer's reply 412 in the chat interaction display section. More specifically, the response 414 displaying text ‘SURE, I CAN HELP YOU WITH THE DETAILS. PLEASE PROVIDE YOUR PHONE NUMBER’ corresponds to the trending response 432 selected by the second agent for responding to second customer's (i.e. LARA's) reply 412.

In some embodiments, while the second agent is typing a response using a form field 460, the processor 202 may be configured to analyze the words being typed and match it with one or more trending responses stored in the database 250. The matched response may be displayed by the processor 202 in the form field 460 as an auto-completion feature of the response. The second agent may then need to only click the button 470 labeled ‘SEND’ to send the response to second customer if the auto-completed response is found suitable by the agent.

In some embodiments, the second agent may proactively select an intent of the interaction from among the relevant intents displayed in the portion 420. For example, the second agent may provide a selection input corresponding to the ‘#BILL HIGH’ intent displayed in the portion 420 subsequent to receiving the reply 412 from the second customer, i.e. Lara. Upon receiving intent selection from the second agent, the processor 202 may be configured to display the one or more trending responses tagged to the intent ‘#BILL HIGH’ for agent selection as explained above.

Such tagging and sharing of responses by agents facilitates active collaboration among agents, which not only helps in providing high quality responses to customers in a timely manner but also helps in reducing Average Handle Time (AHT) of agents.

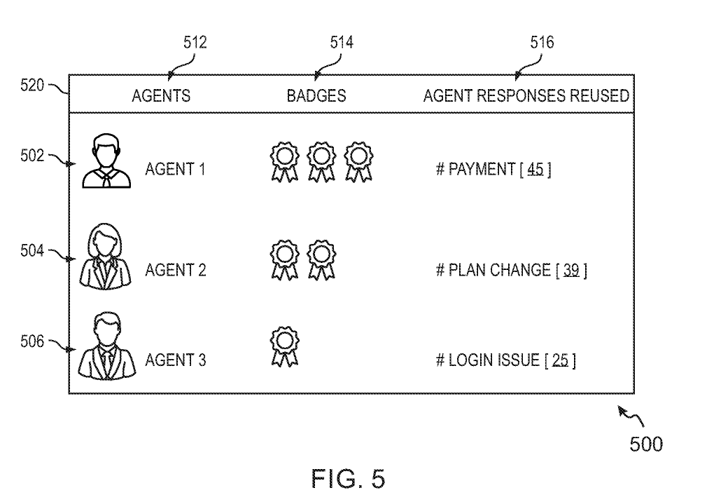

Referring now to FIG. 2, in at least one example embodiment, the processor 202 is configured to provide an agent dashboard accessible to a plurality of agents. The agent dashboard corresponds to a social network dashboard and includes a portion configured to display badges awarded to agents associated with most number of trending responses within a predefined time period. The predefined time period may be any user configurable time period, such as daily, weekly, monthly, quarterly, annually, and the like. Some agents may have contributed say five responses for various intents, which are trending, within a month's time period. Such agents are also referred to herein as ‘trending agents’. An example portion of the UI associated with the agent dashboard in shown in FIG. 5.

Referring now to FIG. 5, a simplified representation of a UI 500 displaying trending agents based on the recurrent usage of their responses by fellow agents is shown, in accordance with an embodiment of the invention. The UI 500 may correspond to a portion of an agent social dashboard in use by agents of an enterprise. In some embodiments, the UI 500 by itself may configure the agent dashboard for enterprise agents. In some embodiments, the UI 500 may be displayed on a portion of the agent console using which an agent is communicating with the customers of the enterprise.

The UI 500 is depicted to include a header section 520 displaying a plurality of headers such as a header 512 labeled ‘AGENTS’, a header 514 labeled ‘BADGES’ and a header 516 labeled ‘AGENT RESPONSES REUSED’. The header 512 labeled ‘AGENTS’ is associated with a listing of trending agents of the enterprise (exemplarily depicted as AGENT 1, AGENT 2, and AGENT 3). The header 514 labeled ‘BADGES’ is associated with information related to a number of badges earned/received by the trending agents and the header 516 labeled ‘AGENT RESPONSES REUSED’ displays information about the maximum number of times a response of a trending agent has been recurrently used by fellow agents during their interactions with the customers. As explained with reference to FIG. 3C, the processor 202 maintains a track of a count of a number of times an agent response is used in agent interactions with the customers. Such tracked information may facilitate identifying trending responses and trending agents, such as the agents 1, 2 and 3.

As shown in row 502, the AGENT 1 is depicted to have earned three badges, for example for having more than five trending responses, with a response corresponding to intent ‘#PAYMENT’ being used 45 times by fellow agents. Similarly, row 504 depicts AGENT 2 to have earned two badges, for example for having three to five trending responses, with a response corresponding to the intent ‘PLAN CHANGE’ being used 39 times by fellow agents. Row 506 depicts the AGENT 3 to have earned one badge for having two trending responses with a response corresponding to the intent ‘LOGIN ISSUE’ being used 25 times by fellow agents. It is noted that UI 500 may also enable agents to like, up-vote and share responses with fellow agents. In one embodiment, an agent's expertise or credibility may be determined based on the number of times his/her responses are reused, liked, approved, up-voted, etc. In some embodiments, the processor 202 may be configured to display a list of all responses on the agent console, which have been tagged by the agent during his/her interactions with a plurality of customers. In some embodiments, the agent dashboard is further configured to display information related to a contribution of each agent to a repository of trending responses, i.e. to a datastore in the database 250, in the portion of the agent dashboard, i.e. in UI 500. For example, Agent A may have contributed

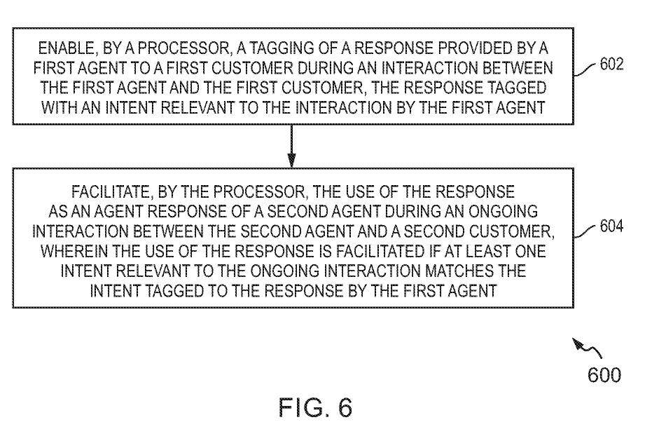

A method for facilitating collaboration among enterprise agents is explained next with reference to FIG. 6.

FIG. 6 is a flow diagram of an example method 600 for facilitating collaboration among enterprise agents, in accordance with an embodiment of the invention. The method 600 depicted in the flow diagram may be executed by, for example, the system 200 explained with reference to FIGS. 2 to 5. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with help of the system 200. The operations of the method 600 can be described and/or practiced by using any system other than the system 200. The method 600 starts at operation 602.

At operation 602 of the method 600, a tagging of a response provided by a first agent to a first customer during an interaction between the first agent and the first customer is enabled by a processor such as the processor 202 of the system 200 explained with reference to FIGS. 2 to 5. The response is tagged by the first agent with an intent relevant to the interaction by the first agent. As explained with reference to FIGS. 3A and 3B, an agent, such as the first agent may provide a selection input on a response that the first agent wishes to tag. The first agent may wish to tag a response for various reasons. In an illustrative example, the agent may wish to tag a response if the agent feels that the customer has responded favorably to a response or liked the response. In another illustrative example, the agent may wish to tag a response if the response resulted in a preferred outcome such as for example, a completed purchase transaction, a satisfactory end to a customer complaint, a high CSAT or NPS score, and the like. In yet another illustrative example, the agent may wish to tag a response if the response caused a positive change in customer sentiment, for example an irate customer was soothed by the response, etc. In still another illustrative example, the agent may wish to tag a response if the agent believes that other agents may be faced with a similar query and the response will be helpful to other agents.

The processor, on receiving on the selection input on the response provided by the first agent, may provide a plurality of options to the first agent to tag at least one intent with the response. The plurality of options provided to the first agent may include a listing of predefined intents, as shown in FIG. 3B, and a customization option to define a custom intent. If the first agent chooses to define a custom intent, then the processor may be configured to cause a display of a form field to receive a textual input corresponding to the custom intent. The textual input is representative of the intent to be tagged to the response. Alternatively, the first agent may provide a choice of an option from among the plurality of options to indicate an intent to be tagged with the selected response. Such providing of the choice of the option is shown in FIG. 3B in form of selection of the intent ‘#SIGNAL ERROR’. On receipt of the choice of the option, or more specifically, on receipt of the choice of the intent, the processor may be configured to tag the response with the intent, i.e. associate the intent with the selected response. The processor may further be configured to store the response tagged with the intent in a database, such as the database 250 shown in FIG. 2. Thus, the provisioning of options on receipt of a selection input on an agent response, enables the first agent to tag the response with an intent relevant to the interaction.

At operation 604 of the method 600, the use of the response as an agent response of a second agent during an ongoing interaction between the second agent and a second customer is facilitated by the processor. The ongoing interaction between the second agent and the second customer is initiated after a completion of the interaction between the first agent and the first customer. More specifically, the response tagged with the intent by a first agent may be used as an agent response of another agent, i.e. the second agent, in an interaction of the second agent with another customer, thereby improving an AHT of the second agent and, in some cases, also provide improved responses to the second customer.

To facilitate the use of the first agent's response in a separate interaction between the second agent and the second customer, the processor is configured to cause a display of the response during the ongoing interaction between the second agent and the second customer if the at least one intent relevant to the ongoing interaction matches the intent tagged to the response by the first agent. More specifically, the processor may be configured to predict an intent relevant to the interaction between the second agent and the second customer and identify responses that are tagged with the predicted intent. In other words, the use of the response of the first agent in the interaction between the second agent and the second customer is facilitated only if at least one intent relevant to the interaction between the second agent and the second customer matches the intent tagged to the response by the first agent. In some embodiments, the most popular among the identified responses, also referred to herein as ‘trending responses’, may be displayed to the second agent during the ongoing interaction between the second agent and the second customer. In an example scenario, the response provided by the first agent may be selected as a trending response suitable for display to the second agent.

The second agent may provide a selection of the displayed response to indicate a wish to use the response of the first agent as an agent response to a current query of the second customer. On receipt of the selection of the displayed response, the response of the first agent is used as an agent response of the second agent in the ongoing interaction between the second agent and the second customer. Thus, the tagging of responses with intents and the subsequent use of the responses by fellow agents facilitates collaboration among enterprise agents and assists them in providing high quality responses in a timely manner. The method 600 ends at 604.

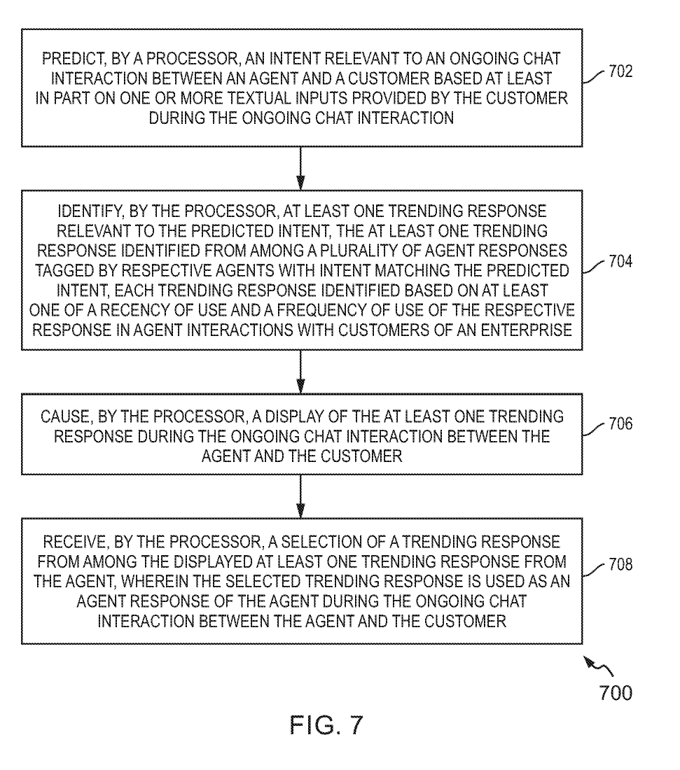

FIG. 7 is a flow diagram of an example method 700 for facilitating collaboration among enterprise agents, in accordance with another embodiment of the invention. Operations of the flowchart, and combinations of operation in the flowchart, may be implemented by, for example, hardware, firmware, a processor, circuitry, and/or a different device associated with the execution of software that includes one or more computer program instructions. The operations of the method 700 are described herein with help of the system 200. It is noted that, the operations of the method 700 can be described and/or practiced by using any system other than the system 200. The method 700 starts at operation 702.

At operation 702 of the method 700, an intent relevant to an ongoing chat interaction between an agent and a customer is predicted based at least in part on one or more textual inputs provided by the customer during the ongoing chat interaction. The intent relevant to the ongoing interaction, i.e. the customer's intent, may be predicted as explained with reference to FIG. 2 and is not explained herein.

At operation 704 of the method 700, at least one trending response relevant to the predicted intent is identified. As explained with reference to FIG. 2, the repeated selection of some tagged responses in agent interactions causes those responses to trend and be shown on the agent consoles for possible inclusion in their interactions. The tagged responses may trend not only based on their frequent usage in interactions by fellow agents but in some cases, the responses which are related to recent events or the responses, which are associated with the highest Net Promoter Score (NPS), Customer Satisfaction Score (CSAT), etc. may also trend and accordingly be displayed on the agent consoles. Some examples of recent event may be a power outage event, a sudden change in weather causing disruption of services, a local event such as a political rally or a union strike or a global event of local significance, etc.

The processor 202 may be configured to identify the at least one trending response from among a plurality of agent responses tagged by respective agents with intent matching the predicted intent. For example, if an intent predicted for an ongoing interaction between an agent and a customer corresponds to ‘#PAYMENT’ intent, then all the responses tagged with such an intent, i.e. with matching intent, may be retrieved from the database 250. Then, one or more responses among the retrieved responses which are used most frequently and/or most recently are identified as trending responses relevant to the predicted intent. The processor 202 is further configured to cause a display of at least one trending response during the ongoing chat interaction between the agent and the customer.

At operation 706 of the method 700, a display of the at least one trending response is caused during the ongoing chat interaction between the agent and the customer by the processor. An example display of an trending response is shown in FIG. 4B. At operation 708 of the method 700, a selection of a trending response from among the displayed at least one trending response is received from the agent. The selected trending response is used as an agent response of the agent during the ongoing chat interaction between the agent and the customer. The use of the trending response of another agent as a current agent response by the agent is explained with reference to FIG. 4B and is not explained again herein. The method 700 ends at operation 708.

Without in any way limiting the scope, interpretation, or application of the claims appearing below, advantages of one or more of the exemplary embodiments disclosed herein provide numerous advantages. The embodiments disclosed herein provide techniques for facilitating collaboration among enterprise agents. Agents may tag responses that they believe may be useful for fellow agents. Such responses may be made available to other agents during their ongoing interactions based on the match of intents between the ongoing conversation and the tagged response. Such tagging and sharing of responses by agents facilitates active collaboration among agents, which not only helps in providing high quality responses to customers in a timely manner but also helps in reducing Average Handle Time (AHT) of agents. Moreover, rewarding agents whose tagged responses are being used frequently may motivate other agents to collaborate and increase camaraderie amongst enterprise agents.

Various embodiments described above may be implemented in software, hardware, application logic or a combination of software, hardware and application logic. The software, application logic and/or hardware may reside on one or more memory locations, one or more processors, an electronic device or, a computer program product. In an embodiment, the application logic, software or an instruction set is maintained on any one of various conventional computer-readable media. In the context of this document, a “computer-readable medium” may be any media or means that can contain, store, communicate, propagate or transport the instructions for use by or in connection with a system, as described and depicted in FIG. 2. A computer-readable medium may include a computer-readable storage medium that may be any media or means that can contain or store the instructions for use by or in connection with an instruction execution system, system, or device, such as a computer.

Although the invention has been described with reference to specific exemplary embodiments, it is noted that various modifications and changes may be made to these embodiments without departing from the broad spirit and scope of the invention. For example, the various operations, blocks, etc., described herein, may be enabled and operated using hardware circuitry, for example complementary metal oxide semiconductor (CMOS) based logic circuitry; firmware; software; and/or any combination of hardware, firmware, and/or software, for example embodied in a machine-readable medium. For example, the systems and methods may be embodied using transistors, logic gates, and electrical circuits, for example application specific integrated circuit (ASIC) circuitry and/or in Digital Signal Processor (DSP) circuitry.

Particularly, the system 200 and its various components, such as the processor 202, the memory 204, the I/O module 206, the communication module 208, the database 250, and the centralized circuit system 212 may be enabled using software and/or using transistors, logic gates, and electrical circuits, for example integrated circuit circuitry such as ASIC circuitry. Various embodiments of the invention may include one or more computer programs stored or otherwise embodied on a computer-readable medium, wherein the computer programs are configured to cause a processor or computer to perform one or more operations, for example operations explained herein with reference to FIGS. 6 and 7. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media, such as floppy disks, magnetic tapes, hard disk drives, etc.; optical magnetic storage media, e.g. magneto-optical disks, CD-ROM (compact disc read only memory), CD-R (compact disc recordable), CD-R/W (compact disc rewritable), DVD (Digital Versatile Disc), BD (Blu-ray (registered trademark) Disc); and semiconductor memories, such as mask ROM, PROM (programmable ROM), EPROM (erasable PROM), flash ROM, RAM (random access memory), etc. Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line, e.g. electric wires and optical fibers, or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the present invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method for facilitating collaboration among agents of an enterprise, comprising:
enabling, by a processor, a tagging of a response provided by a first agent to a first customer during an interaction between the first agent and the first customer, the response tagged with an intent relevant to the interaction by the first agent; and
facilitating, by the processor, the use of the response as an agent response of a second agent during an ongoing interaction between the second agent and a second customer, the use of the response facilitated when at least one intent relevant to the ongoing interaction matches the intent tagged to the response by the first agent, the ongoing interaction between the second agent and the second customer initiated after a completion of the interaction between the first agent and the first customer.

2. The method as claimed in claim 1, wherein enabling the tagging of the response comprises:
receiving, by the processor, a selection input on the response provided by the first agent to the first customer during the interaction between the first agent and the first customer;
in response to a receipt of the selection input providing, by the processor, a plurality of options to the first agent to tag one or more intents with the response;
receiving, by the processor, a choice of an option from among the plurality of options from the first agent, the choice of the option indicative of the intent to be tagged to the selected response;
tagging, by the processor, the response with the intent based on the choice of the option provided by the first agent; and
storing, by the processor, the response tagged with the intent in a database.

3. The method as claimed in claim 2, wherein the plurality of options provided to the first agent comprises a listing of predefined intents and a customization option to define a custom intent.

4. The method as claimed in claim 3, further comprising:
causing, by the processor, a display of a form field to receive a textual input corresponding to the custom intent subsequent to a selection of the customization option by the first agent, wherein the textual input is representative of the intent to be tagged to the response.

5. The method as claimed in claim 2, wherein facilitating the use of the response comprises:
causing, by the processor, a display of the response during the ongoing interaction between the second agent and the second customer when the at least one intent relevant to the ongoing interaction matches the intent tagged to the response by the first agent; and
receiving, by the processor, a selection of the displayed response from the second agent, wherein the response is used as the agent response of the second agent during the ongoing interaction subsequent to a receipt of the selection of the displayed response.

6. The method as claimed in claim 1, further comprising:
tracking, by the processor, a count and a time of use of the response provided by the first agent in interactions of other agents with customers of the enterprise.

7. The method as claimed in claim 1, further comprising:
for the ongoing interaction between the second agent and the second customer predicting, by the processor, the intent relevant to the ongoing interaction, the intent predicted based at least in part on one or more textual inputs provided by the second customer during the ongoing interaction.

8. The method as claimed in claim 7, further comprising:
identifying, by the processor, at least one trending response relevant to the predicted intent, the at least one trending response identified from among a plurality of agent responses tagged with intent matching the predicted intent, each trending response identified based on at least one of a recency of use and a frequency of use of the respective response in agent interactions with customers of the enterprise;
causing, by the processor, a display of the at least one trending response during the ongoing interaction between the second agent and the second customer; and
selecting the response provided by the first agent as a trending response suitable for display during the ongoing interaction.

9. The method as claimed in claim 8, further comprising:
providing, by the processor, an agent dashboard accessible to a plurality of agents, the agent dashboard comprising a portion configured to display badges awarded to agents associated with most number of trending responses within a predefined time period.

10. The method as claimed in claim 9, wherein the agent dashboard is further configured to display information related to a contribution to a repository of trending responses for at least one agent in the portion.

11. The method as claimed in claim 1, wherein the response tagged with the intent by the first agent corresponds to at least one of:
a response liked by the first customer,
a response that resulted in a preferred outcome;
a response likely to be useful to other agents; and
a response that caused a positive change in customer sentiment.

12. A system for facilitating collaboration among agents of an enterprise, the system comprising:
a memory for storing instructions; and
a processor configured to execute the instructions and thereby cause the system to at least perform the steps of:
tagging a response provided by a first agent to a first customer during an interaction between the first agent and the first customer, the response tagged with an intent relevant to the interaction by the first agent; and
facilitating use of the response as an agent response of a second agent during an ongoing interaction between the second agent and a second customer, the use of the response facilitated if at least one intent relevant to the ongoing interaction matches the intent tagged to the response by the first agent, the ongoing interaction between the second agent and the second customer initiated after a completion of the interaction between the first agent and the first customer.

13. The system as claimed in claim 12, wherein for enabling the tagging of the response the system is further caused to:
receive a selection input on the response provided by the first agent to the first customer during the interaction between the first agent and the first customer;
in response to a receipt of the selection input, provide a plurality of options to the first agent to tag one or more intents with the response;
receive a choice of an option from among the plurality of options from the first agent, the choice of the option indicative of the intent to be tagged to the selected response;
tag the response with the intent based on the choice of the option provided by the first agent; and
store the response tagged with the intent in a database.

14. The system as claimed in claim 13, wherein the plurality of options provided to the first agent comprises a listing of predefined intents and a customization option to define a custom intent.

15. The system as claimed in claim 13, wherein for facilitating the use of the response the system is further caused to:
cause a display of the response during the ongoing interaction between the second agent and the second customer if the at least one intent relevant to the ongoing interaction matches the intent tagged to the response by the first agent; and
receive a selection of the displayed response from the second agent, wherein the response is used as the agent response of the second agent during the ongoing interaction subsequent to a receipt of the selection of the displayed response.

16. The system as claimed in claim 12, wherein the system is further caused to:
for the ongoing interaction between the second agent and the second customer, predict the intent relevant to the ongoing interaction, the intent predicted based at least in part on one or more textual inputs provided by the second customer during the ongoing interaction;
identify at least one trending response relevant to the predicted intent, the at least one trending response identified from among a plurality of agent responses tagged with intent matching the predicted intent, each trending response identified based on at least one of a recency of use and a frequency of use of the respective response in agent interactions with customers of the enterprise;
cause a display of the at least one trending response during the ongoing interaction between the second agent and the second customer;
select the response provided by the first agent as a trending response suitable for display during the ongoing interaction.

17. The system as claimed in claim 16, wherein the system is further caused to:
provide an agent dashboard accessible to a plurality of agents, the agent dashboard comprising a portion configured to display badges awarded to agents associated with most number of trending responses within a predefined time period.

18. A computer-implemented method for facilitating collaboration among agents of an enterprise, the method comprising:
predicting, by a processor, an intent relevant to an ongoing chat interaction between an agent and a customer based at least in part on one or more textual inputs provided by the customer during the ongoing chat interaction;
identifying, by the processor, at least one trending response relevant to the predicted intent, the at least one trending response identified from among a plurality of agent responses tagged by respective agents with intent matching the predicted intent, each trending response identified based on at least one of a recency of use and a frequency of use of the respective response in agent interactions with customers of the enterprise;
causing, by the processor, a display of the at least one trending response during the ongoing chat interaction between the agent and the customer;
receiving, by the processor, a selection of a trending response from among the displayed at least one trending response from the agent; and
using the selected trending response as an agent response of the agent during the ongoing chat interaction between the agent and the customer.

19. The method as claimed in claim 18, further comprising:
providing, by the processor, an agent dashboard accessible to a plurality of agents, the agent dashboard comprising a portion configured to display badges awarded to agents associated with most number of trending responses within a predefined time period.

20. The method as claimed in claim 18, wherein the response tagged with the intent by an agent corresponds to at least one of:
a response liked by the customer,
a response that resulted in a preferred outcome;
a response likely to be useful to other agents; and
a response that caused a positive change in customer sentiment.
